(19) United States
(12) Patent Application Publication
(10) Pub. No.: US 2012/0188356 A1
(43) Pub. Date: Jul. 26, 2012

(54) METHOD AND EXAMINATION DEVICE FOR IMAGING AN ORGAN

(75) Inventors: Ilkka Jolma, Oulu (FI); Markku Virta, Kempele (FI); Mikko Tuohimaa, Kempele (FI); Juha Lipponen, Oulu (FI)

(73) Assignee: Optomed Oy, Oulu (FI)

(21) Appl. No.: 13/498,198

(22) PCT Filed: Nov. 16, 2010
(86) PCT No.: PCT/FI2010/050920

§ 371 Date: Mar. 26, 2012

(30) Foreign Application Priority Data
Nov. 17, 2009 (FI) 20096190

(51) Int. Cl. H04N 7/18

(52) U.S. Cl. 348/78; 348/E07.085; 348/E05.09

(57) ABSTRACT

A hand-held examination device for imaging the eye (106) comprises a user interface (108), infrared source (150) and visible light source (152). The infrared source (150) illuminates the eye (106) with infrared radiation, the examination device forms an image of the eye (106) while illuminated by infrared radiation, and the display shows the eye (106) illuminated by infrared radiation. The user interface (108) receives from the user a signal for generating an image. The visible light source (152) is switched on in a predefined manner in response to the received user signal for generating the image. The examination device generates at least one image of the eye (106) by using visible light in response to the received user signal for generating the image.

### FIELD

The invention relates to a method and examination device for imaging an organ being examined.

### BACKGROUND

When examining eyes, it is possible to utilise a portable digital examination device, the electric image formed by which can be viewed on the display of the portable examination device. The examination device may comprise a common digital camera unit intended for examining different organs, and several optical components attachable to and detachable from the camera unit and serving as the objectives of the camera unit. One of these optical components may be specifically intended for the examination of the eye, which makes the examination efficient.

When imaging the eye, the eye is illuminated with visible light, which makes the pupil of the eye smaller and prevents proper examination of the eye. In the prior art, this problem has been solved by putting into the eye prior to the examination a substance that dilates the pupils, for instance atropine. The substance that dilates the pupils is effective long after the examination, and dilated pupils are inconvenient and harmful for the examined person or animal, because daylight and lamps dazzle, and focusing may be difficult. Therefore, there is a need to improve eye examination.

### BRIEF DESCRIPTION

It is an object of the invention to provide an improved examination device. This is achieved by a hand-held examination device for imaging the eye, the examination device comprising a camera unit with a display, an optical component repeatedly attachable to and detachable from the camera unit and intended for examining the eye. The examination device comprises a user interface, infrared source and visible light source; the infrared source being configured to illuminate the eye with infrared radiation, the examination device being configured to generate an image of the eye while illuminated by infrared radiation, and the display being configured to display the eye illuminated by infrared radiation; the user interface being configured to receive a signal for generating an image and input by the user; the visible light source being configured to switch on in a predefined manner in response to a signal received from the user for generating an image; and the examination device being configured to generate at least one image of the eye under visible light in response to the signal received from the user for generating an image.

The invention also relates to a method for imaging the eye with a hand-held examination device that comprises a camera unit with a display, an optical component repeatedly attachable to and detachable from the camera unit and intended for examining the eye. The method further comprises illuminating the eye with infrared radiation from the infrared source, generating an image of the eye while illuminated by infrared radiation, and displaying the eye illuminated by infrared radiation on the display; receiving from the user interface a signal input by the user for generating the image; switching the visible light source on in a predefined manner in response to receiving the user's signal for generating the image; and generating at least one image of the eye in visible light in response to receiving the user's signal for generating the image.

Preferred embodiments of the invention are disclosed in the dependent claims.

The method and performance measurement system of the invention provide several advantages. A substance dilating the pupils need not be used. An image can be generated of the eye in visible light while the pupil remains dilated, which enables extensive imaging of the fundus of the eye.

### LIST OF FIGURES

The invention will now be described in greater detail by means of preferred embodiments and with reference to the accompanying drawings, in which:

FIG. 1 shows an examination device,

FIG. 2 shows an optical component,

FIG. 3 shows an alternative positioning of optical radiation sources,

FIG. 4A shows a focusing mechanism of an image,

FIG. 4B shows another type of focusing mechanism,

FIG. 5 shows the size of a pupil and the generation of images as a function of time,

FIG. 6 shows an aspheric lens in an optical component, and

FIG. 7 shows a flow chart of the method.

### DESCRIPTION OF EMBODIMENTS

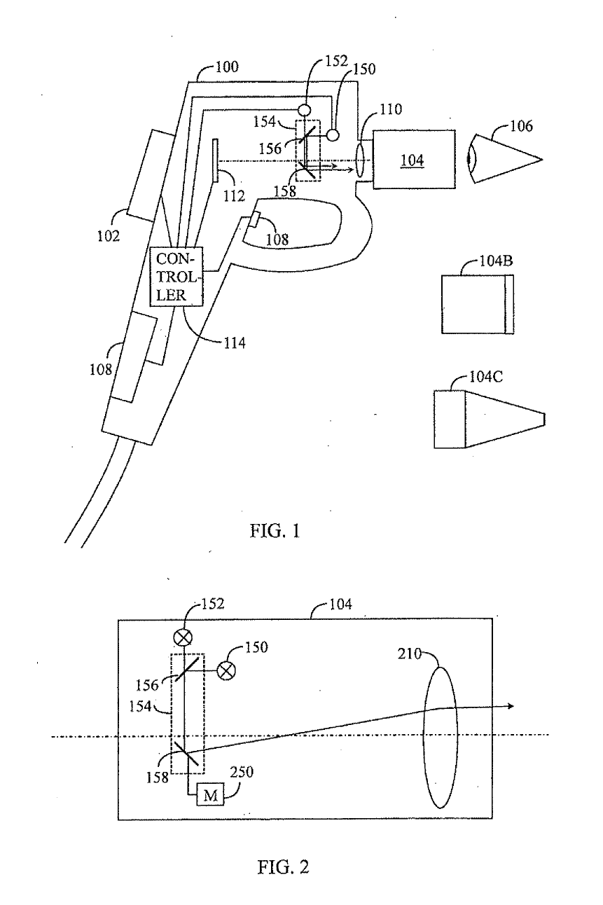

Let us first examine the examination device in general by means of FIG. 1. The examination device is a hand-held camera based on digital technology. The examination device comprises a camera unit 100 that comprises a display 102, and one or more optical components 104, 104B, 104C that are repeatedly attachable and detachable. One or more optical components having suitable imaging optics may be connected to the examination device depending on the object of the examination. For instance, the optical component 104B may be intended for examining the skin and the optical component 104C for examining the ear. The optical component 104 is intended for imaging the eye 106. Often, the fundus of the eye (retina) needs to be examined, but an examination of the surface of the eye, for instance the cornea, is also possible. The examination device may also comprise a user interface 108 and power source (not shown in the figures) that may be an accumulator, battery, or a power source obtaining its electric power from the mains.

The camera unit 100 of the examination device may comprise an optical element 110, such as one or more lenses that may participate in generating an image of the organ to a detector 112 of the camera unit 100. However, the optical element 110 is not essential. When the examination device is in working order, the detector 112 may generate an image in electrical form of an eye 106 being examined, for example. The image generated by the detector 112 may be fed to a controller 114 of the camera unit 100, which may comprise a processor, a memory, and a suitable computer program for controlling the camera unit 100, and processing and storing the image and other possible data. The image may be fed from the controller 114 or directly from the detector 112 to the display of the camera unit 100 for displaying the image and possible other data. The detector 112 of the camera unit 100 may be a CCD (Charge Coupled Device) cell, CMOS (Complementary Metal Oxide Semiconductor) cell, or some other image detector, and the camera unit 100 may generate still images or video images.

Each optical component 104 to 104C is intended on its own or together with at least one other optical component 104 to 1040 to generate an image of a predefined organ.

The camera unit 100 may comprise an infrared source 150 and a visible light source 152. Two optical radiation sources 150, 152 are marked in FIG. 1, but in general the camera unit 100 may have even more optical radiation sources. Each optical radiation source 150, 152 may receive its electrical power from the camera unit 100. The camera unit 100 may comprise a beam splitter 156 and mirror 158 that form a guidance structure 154 of optical radiation. In an embodiment, the infrared source 150 comprises at least one LED (Light emitting diode). In one embodiment, the visible light source 152 comprises at least one LED. The LED efficiently transforms electrical energy into radiation specific for its operation.

The visible light source 152 may illuminate the eye with white light or a required narrower or discrete wavelength band. For instance, green light may be used to generate an image of the blood vessels in the fundus of the eye to improve resolution. Blue light in turn may be used in fluorescent angiography.

In an embodiment, the infrared source 150 directs optical radiation to the guidance structure 154 of optical radiation, the beam splitter 156 of which reflects the infrared radiation to a mirror 158. The mirror 158 in turn reflects the infrared radiation through the optical element 110 of the optical component 104 toward the eye being examined. The visible light source 152 directs its radiation to the guidance structure 154, which the beam splitter 156 penetrates, and the visible light propagates to the mirror 158. The mirror 158 in turn reflects the visible light through a lens unit 210 toward the eye 106 being examined in the same direction and along the same axis as the infrared radiation (however, in FIG. 1, the beams are drawn as having slightly different axes).

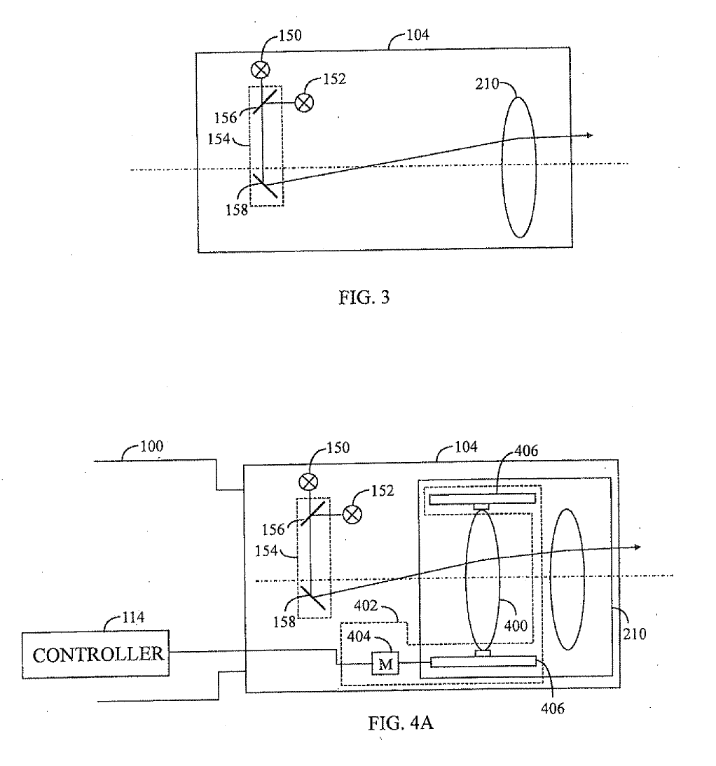

Alternatively in another embodiment, the infrared source 150 and the visible light source 152 have changed places in relation to the guidance structure. The beam splitter 156 of the guidance structure 154 then reflects visible light into the mirror 158. The mirror 158 reflects the visible light through the lens unit 156 toward the eye 106. In this embodiment, the infrared source 150 directs its radiation to the guidance structure 154 and on through its beam splitter 156 to the mirror 158. The mirror 158 reflects the infrared radiation through the lens unit 212 to the eye in the same direction and along the same axis as the visible light. The principle of this solution is shown in FIG. 3, but otherwise FIG. 3 relates to the optical component 104.

Let us now examine the optical component 104 intended for imaging the eye in more detail and by means of FIG. 2. The optical component 104 may comprise an infrared source 150 and a visible light source 152. Two optical radiation sources 150, 152 are marked in the optical component 104 of FIG. 2, but in general the optical component 104 may have even more optical radiation sources. Each optical radiation source 150, 152 may reside inside the optical component 104, and each optical radiation source 150, 152 may receive its electrical power from the camera unit 100. The optical component 104 may also comprise an optical radiation guidance structure 154 that comprises a beam splitter 156 and mirror 158.

In an embodiment, the infrared source 150 directs optical radiation to the optical radiation guidance structure 154, the beam splitter 156 of which reflects the infrared radiation to the mirror 158. The mirror 158 in turn reflects the infrared radiation through the lens unit 210 of the optical component 104 toward the eye being examined. The visible light source 152 directs its radiation to the guidance structure 154, which the beam splitter 156 penetrates, and the visible light propagates to the mirror 158. The mirror 158 in turn reflects the visible light through the lens unit 210 toward the eye being examined in the same direction and along the same axis as the infrared radiation.

The optical radiation guidance structure 154 is controllable to the required position during imaging. For instance, the mirror 158 can be moved by means of a motor 250. The motor 250 in turn may be controlled by a controller 114 that may receive control commands of the user from the user interface 108. This way, optical radiation can be directed to the eye from the required direction in the required manner. When imaging the fundus of the eye, for instance, optical radiation can be directed and/or the direction of optical radiation changed, whereby the fundus of the eye can be seen more clearly.

FIG. 3 shows an embodiment, in which the beam splitter 156 of the guidance structure 154 reflects visible light into the mirror 158. The mirror 158 reflects the visible light through the lens unit 156 toward the eye. In this embodiment, the infrared source 150 directs its radiation to the guidance structure 154 and on through its beam splitter 156 to the mirror 158. The mirror 158 reflects the infrared radiation through the lens unit 210 to the eye in the same direction and along the same axis as the visible light.

In FIGS. 2 and 3, the mirror 158 may reside on a different axis with respect to the optical axis 158 of the optical component. In the case of FIG. 2, the beam splitter 156 may be a “hot mirror”. In the case of FIG. 3, the beam splitter 156 may be a “cold mirror”. A prism may also be used as the mirror 158.

When the infrared source 150 illuminates the eye with infrared radiation, the examination device generates continuous video images of the eye illuminated by the infrared radiation, and the display 102 displays the infrared radiation-illuminated eye to the user in real time.

When the user wants to generate an image of the eye by using visible light, the user interacts with the user interface 108. The interaction may be that the user presses a button triggering the generation of the image, for instance. The user interface 108 then receives from the user the signal for generating the image.

In response to the received user signal for generating the image, the visible light source 152 is switched on in a predetermined manner and the examination device generates at least one still image of the eye by using visible light. This may be performed in such a manner, for instance, that the pressing of the button of the user interface 108 generates an electric signal that is fed into the controller 114. The controller 114 may control the visible light source 152 to switch on. The controller 114 also controls that the image generated by the detector 112 by using visible light is stored into the memory. The controller 114 may control the display 102 to show the image generated using visible light, but this function is not necessary during the examination and the image(s) may also be shown after the examination on the display 102, or each image may further be transferred to an external computer, on the display of which the images may later be viewed.

In one embodiment, the optical radiation of all optical radiation sources 150, 152 may be non-polarized or polarized in the same manner. Alternatively, the optical radiation of at least two optical radiation sources 150, 152 may differ from each other in polarization. Optical radiation polarized in different manners may reflect in different ways from different objects, and may thus help in distinguishing and detecting different objects. If a change in polarization between transmitted and received optical radiation is defined at reception, a desired characteristic of the object may be defined on the basis of the change.

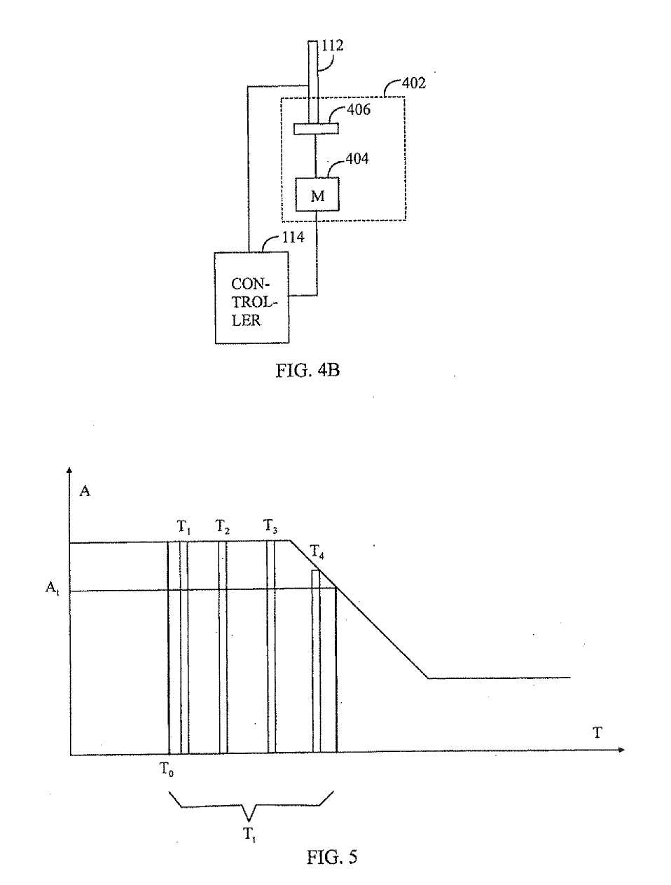

FIG. 4A shows one embodiment, in which at least one optical part 400, such as a lens, of the lens unit 210 of the optical component 104 may move for the purpose of focusing the image. The moving lens may be used to change the refractive power of the optical component 104, which enables focusing at different distances. Instead of a lens, the optical part 400 may be a mirror or prism pair, the distance between which may be changed to lengthen or shorten the distance the optical radiation travels in the optical component 104.

The optical component 104 may comprise a focusing unit 402 of the optical part 400 which may comprise for instance a motor 404 and bracket 406 of the optical part 400 enabling its movement. The operation of the focusing unit 402 is controlled by the controller 114. When the eye is examined by infrared radiation, the controller 114 controls the focusing unit 402 to move said at least one part 400 of the lens unit 210 to a location that provides an exact image to the detector 112 with infrared radiation. When an image is generated in visible light, the controller 114 moves said at least one optical part 400 of the lens unit 210 to another location that provides an exact image to the detector 112 in visible light. This type of focusing action is necessary, because the refractive power of the optical component 104 is different at different wavelengths. The difference in refractive power caused by the difference in refractive indexes is previously known so the size and direction of the shift of the optical part 400 are predefined. Data related to the shift may be stored into the memory and fetched from the memory at the time of the imaging for the purpose of executing the shift.

Instead of or in addition to moving the optical component 400, the focusing may be done by moving the detector 112 back and forth in the direction of the optical axis with the focusing unit 402, as shown in FIG. 4B. For focusing, the motor 404 may then move the detector 112 that is fastened to a bracket 406 enabling its movement.

The image may also be focused on the detector 112 by moving the shape or refractive index of the lens in the optical part 400. The lens may then contain a liquid to make the lens thicker or thinner. If a liquid crystal is used inside the lens, the refractive index of the liquid crystal may be changed by means of an electrical and/or magnetic field, whereby the refractive power of the optical part changes.

In addition, the examination device may focus the image in eyes having different refractions by moving the optical part 400 by means of the focusing unit 402. The eyes of animals and human beings are of different sizes and thus also refract differently. In addition, the eyes may be myopic, normal, or hyperopic, A dioptre correction of the eye may be easily done by moving the optical part 400 with the focusing unit 402. Instead of moving the optical part 400, it is also possible to perform dioptre correction of the eye by using a liquid lens and/or shifting the detector 112.

FIG. 5 shows an embodiment that generates images before the pupil contracts. The vertical axis shows the size A of the pupil and the horizontal axis shows time T. Both axes are shown on a freely selected scale. Visible light is switched on at time instant T₀. Images are generated at time instants T₁, T₂, T₃ and T₄. Generally, one or more images may be generated. The image or images may be generated of the eye before the pupil contracts to a size smaller than a predefined threshold value Aₜ.

In one embodiment, the optical radiation sources 150, 152 may emit radiation pulses at time instants T₁, T₂, T₃ and T₄. Pulsed radiation may expose the image without the shutter in front of the detector 112 opening and closing. Alternatively, the optical radiation sources 150, 152 may emit continuous radiation, whereby at time instants T₁, T₂, T₃ and T₄ the shutter of the camera unit 100 is opened for the time of generating each image.

The examination device may generate at least two images of the eye 106 in a predefined time Tₜ that is estimated to correspond to the reaction time of the contraction of the eye in visible light.

The examination device may measure the size of the pupil from the image and generate at least two images of the eye before the pupil has, according to the measurements, contracted to a size smaller than the predefined size Aₜ.

When visible light is switched on, the infrared source 200 may be switched off, so that visible light and infrared radiation was not directed simultaneously to the organ being examined. In addition to visible light, infrared radiation may be used to generate images with the examination device.

When at least two images have been generated of the eye, for example, the examination device may combine the images to produce a high dynamic range (HDR) for the tone. The images may be generated using different apertures or exposure times, and the HDR tone data may be combined to exceed the normal 8-bit tone range, to 16- or 32-bit, for example. It is then possible to distinguish in the image objects that otherwise would remain undetected. To reproduce a high dynamic range, an HDR image may be adapted into a conventional image with an 8-bit tone range, for instance. In adapting the tone range, it is possible to use, in addition to or instead of direct exposure blending, tone compression or detail enhancement. These operations may be performed manually or automatically by means of a suitable computer program in the examination device or in a separate computer.

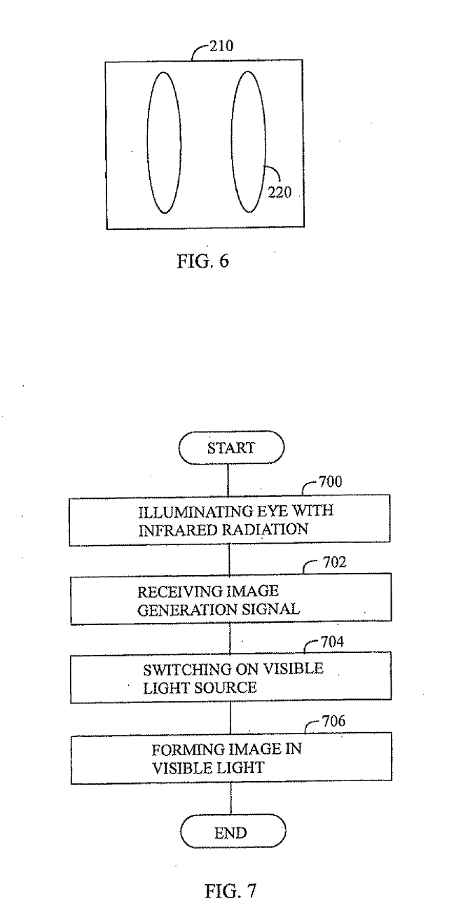

In an embodiment, shown in FIG. 6, the optical part 210 of the optical component may comprise an aspheric lens 220 that may be an objective lens. The eye can be illuminated and imaged through the aspheric lens 220. The aspheric lens 220 makes it possible to direct optical radiation, such as light, efficiently into the eye through the pupil. With enough light in the eye, it illuminates well and quality images can be generated thereof.

It is stated in the above that the infrared source 150 and visible light source 152 are in the optical component 104. However, either source or both sources may be positioned in the camera unit 100 instead of the optical component 104. Similarly, the focusing unit 402 and the moving optical part 400 required for focusing may be positioned in the camera unit 100 instead of the optical component 104.

FIG. 7 shows a flow chart of a method where the eye is imaged with a hand-held examination device comprising a camera unit 100 with a display 102, and an optical component 104 repeatedly attachable to and detachable from the camera unit 100 and intended for imaging the eye 106. In step 700, the eye 106 is illuminated with infrared radiation of the infrared source 150, an image of the eye 106 illuminated by infrared radiation is generated, and the infrared radiation-illuminated eye 106 is shown on the display 102. In step 702, the user interface 108 receives from the user a signal for generating the image. In step 704, the visible light source 152 is switched on in a predefined manner in response to the received user signal for generating the image. In step 706, at least one image is generated of the eye 106 by using visible light in response to the received user signal for generating the image.

The method shown in FIG. 7 may be implemented as a logic circuit solution or computer program. The computer program may be stored on a computer program distribution medium for distribution. The computer program distribution medium is readable with a data processing device and encodes computer program instructions for controlling the operation of a performance measurement system.

The distribution medium may in turn be a solution known per se for distributing a computer program, such as a medium readable by a data processing device, program storage medium, memory readable by a data processing device, software distribution package readable by a data processing device, signal readable by a data processing device, telecommunications signal readable by a data processing device, or compressed software package readable by a data processing device.

Although the invention is described above with reference to the examples according to the accompanying drawings, it is clear that the invention is not restricted thereto, but may be modified in various ways within the scope of the accompanying claims.

1. A hand-held examination device for imaging the eye (106) and comprising a camera unit (100) with a display (102), and an optical component (104) repeatedly attachable to and detachable from the camera unit (100) and intended for imaging the eye (106), characterised in that the examination device comprises a user interface (108), infrared source (150) and visible light source (152);
the infrared source (150) being configured to illuminate the eye (106) with infrared radiation, the examination device being configured to form an image of the eye (106) while illuminated by infrared radiation, and the display (102) being configured to display the eye (106) illuminated by infrared radiation;
the user interface (108) being configured to receive from the user a signal for generating an image;
the visible light source (152) being configured to be switched on in a predefined manner in response to the received user signal for generating the image; and
the examination device being configured to generate at least one image of the eye (106) by using visible light in response to the received user signal for generating the image.

2. An examination device as claimed in claim 1, characterised in that the examination device comprises a focusing unit (402) configured to alter the focus when illumination changes between infrared radiation and visible light.

3. An examination device as claimed in claim 2, characterised in that the examination device comprises an optical part (400), and the focusing unit (402) is configured to move the optical part (400) for altering the focus when illumination changes between infrared radiation and visible light.

4. An examination device as claimed in claim 2, characterised in that the focusing unit (402) is configured to move a detector (112) for altering the focus when illumination changes between infrared radiation and visible light.

5. An examination device as claimed in claim 1, characterised in that the infrared source (150) and visible light source (152) comprise LEDs.

6. An examination device as claimed in claim 1, characterised in that the examination device is configured to generate at least two images of the eye (106) in a predefined time (Tₜ) that is estimated to correspond to the reaction time of the contraction of the eye in visible light.

7. An examination device as claimed in claim 1, characterised in that the examination device is configured to measure the size of the pupil and to generate at least two images of the eye (106) before the pupil has, according to the measurements, contracted to a size smaller than a predefined size (Aₜ).

8. An examination device as claimed in claim 1, characterised in that the examination device is configured to generate at least two images of the eye (106) and to combine the images to provide a high dynamic range for the tone.

9. An examination device as claimed in claim 1, characterised in that the optical component (104) comprises an aspheric lens (220).

10. A method for imaging the eye with a hand-held examination device that comprises a camera unit (100) with a display (102), and an optical component (104) repeatedly attachable to and detachable from the camera unit (100) and intended for imaging the eye (106), characterised by the method comprising
illuminating (700) the eye (106) with infrared radiation from an infrared source (150), forming an image of the eye (106) while illuminated by infrared radiation, and displaying the eye (106) illuminated by infrared radiation an the display (102);
receiving (702) by the user interface (108) from the user a signal for generating an image;
switching (704) the visible light source (152) on in a predefined manner in response to the received user signal for generating the image; and
generating (706) at least one image of the eye (106) by using visible light in response to the received user signal for generating the image.

11. An examination device as claimed in claim 10, characterised by altering the focus with the focusing unit (402) when illumination changes between infrared radiation and visible light.

12. An examination device as claimed in claim 11, characterised by moving with the focusing unit (402) a detector (112) for altering the focus when illumination changes between infrared radiation and visible light.

13. A method as claimed in claim 10, characterised in that the infrared source (150) and visible light source (152) comprise LEDs.

14. A method as claimed in claim 10, characterised by moving with the focusing unit (402) the optical part (400) for altering the focus when illumination changes between infrared radiation and visible light.

15. An examination device as claimed in claim 10, characterised by generating at least two images of the eye (106) in a predefined time (Tₜ) that is estimated to correspond to the reaction time of the contraction of the eye in visible light.

16. A method as claimed in claim 10, characterised by measuring the size of the pupil and generating at least two images of the eye (106) before the pupil has, according to the measurements, contracted to a size smaller than a predefined size (Aₜ).

17. A method as claimed in claim 10, characterised by generating at least two images of the eye (106) and combining the images to provide a high dynamic range for the tone.

18. A method as claimed in claim 10, characterised by illuminating the eye (106) and receiving the light from the eye through an aspheric lens (220) of the optical component (104).
